(19) United States
(12) Patent Application Publication
(10) Pub. No.: US 2006/0176957 A1
(43) Pub. Date: Aug. 10, 2006

(54) Method and apparatus for compressing multi-layered motion vector

(75) Inventors: Woo-jin Han, Suwon-si (KR); Kyo-hyuk Lee, Seoul (KR); Sang-chang Cha, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/348,316

(22) Filed: Feb. 7, 2006

Related U.S. Application Data
(60) Provisional application No. 60/650,173, filed on Feb. 7, 2005.

(30) Foreign Application Priority Data
Apr. 6, 2005 (KR) 10-2005-0028683

(51) Int. Cl. H04N 11/02; H04N 11/04; H04N 7/12; H04B 1/66

(52) U.S. Cl. 375/240.16; 375/240.24

(57) ABSTRACT

A method of compressing a motion vector (MV) of a first macroblock when the region of a first lower layer corresponding to the first macroblock of a current layer frame does not have an MV is provided. The method includes interpolating the MV of a second macroblock to which the region belongs, based on the MV of at least one neighboring macroblock, and predicting the MV of the first macroblock using the interpolated MV.

### CROSS-REFERENCE TO RELATED APPLICATIONS

This application claims priority from Korean Patent Application No. 10-2005-0028683 filed on Apr. 6, 2005 in the Korean Intellectual Property Office, and U.S. Provisional Patent Application No. 60/650,173 filed on Feb. 7, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate generally to video compression and, more particularly, to efficiently predicting the motion vector of a current layer by using the motion vector of a lower layer in a video coder using a multi-layered structure.

2. Description of the Related Art

As information and communication technology, including the Internet, develops, image-based communication as well as text-based communication and voice-based communication is increasing. The existing text-based communication is insufficient to satisfy consumers' various demands. Therefore, the provision of multimedia service capable of accommodating various types of information, such as text, images and music, is increasing. Since the amount of multimedia data is large, multimedia data require high-capacity storage media and require broad bandwidth at the time of transmission. Therefore, to transmit multimedia data, including text, images and audio, it is essential to compress the data.

The fundamental principle of data compression is to eliminate redundancy in data. Data can be compressed by eliminating spatial redundancy such as a case where an identical color or object is repeated in an image, temporal redundancy such as a case where there is little change between neighboring frames or an identical audio sound is repeated, or psychovisual redundancy in which the fact that humans' visual and perceptual abilities are insensitive to high frequencies is taken into account. In a general coding method, temporal redundancy is eliminated using temporal filtering based on motion compensation and spatial redundancy is eliminated using spatial transform.

In order to transmit multimedia data after the redundancy of data is removed, transmission media are necessary. Performance differs according to transmission medium. Currently used transmission media have various transmission speeds ranging from the speed of an ultra high-speed communication network, which can transmit data at a transmission rate of several tens of megabits per second, to the speed of a mobile communication network, which can transmit data at a transmission rate of 384 Kbits per second. In these environments, a scalable video encoding method, which can support transmission media having a variety of speeds or transmit multimedia at a transmission speed suitable for each transmission environment, is required.

Such a scalable video coding method refers to a coding method that allows a video resolution, a frame rate, a Signal-to-Noise Ratio (SNR), etc. to be adjusted by truncating part of an already compressed bitstream in conformity with surrounding conditions, such as a transmission bit rate, a transmission error rate, a system source, etc. With regard to the scalable video encoding method, standardization is in progress in Moving Picture Experts Group-21 (MPEG-21) Part 10. In particular, extensive research into multi-layer based scalability has been carried out. For example, scalability can be implemented in such a way that multiple layers, including a base layer, a first enhanced layer and a second enhanced layer, are provided, and respective layers are constructed to have different resolutions, such as a Quarter Common Intermediate Format (QCIF), a Common Intermediate Format (CIF) or 2CIF, or different frame rates.

In the case of multi-layer based coding, it is necessary to acquire motion vectors (MVs) on a layer basis in order to eliminate temporal redundancy. In a first case, MVs are individually searched for in connection with respective layers. In a second case, an MV is searched for in connection with one layer and is then used for the other layers without change or through up/down sampling.

The first case is advantageous in that accurate MVs can be acquired, but is disadvantageous in that MVs generated for respective layers act as overhead, compared to the latter. Since the accuracy of the MVs significantly affects the reduction in the temporal redundancy of texture data, a method of searching for accurate MVs for respective layers, as in the first case, is generally used. Further, in the first case, it is very important to efficiently eliminate redundancy between MVs for respective layers.

FIG. 1 is a diagram showing an example of a conventional scalable video codec using a multi-layer structure. First, a base layer is defined as a layer having a QCIF and a frame rate of 15 Hz, a first enhanced layer is defined as a layer having a CIF and a frame rate of 30 Hz, and a second enhanced layer is defined as a layer having Standard Definition (SD) and a frame rate of 60 Hz. If a 0.5 Mbps CIF stream is desired, a bitstream may be truncated and transmitted to reach a bit rate of 0.5 Mbps based on a first enhanced layer having a CIF, a frame rate of 30 Hz and a bit rate of 0.7 Mbps. In this manner, spatial scalability, temporal scalability and SNR scalability can be implemented.

If MVs are acquired for respective layers in such a multi-layered video codec, overhead twice that of an existing single layer codec is generated, so that a method of predicting the MV of an upper layer using an MV of a lower layer, that is, motion prediction, is very important. Of course, since such an MV is used only in an inter macroblock that is encoded with reference to temporally neighboring frames, it is not used in an intra macroblock that is encoded regardless of neighboring frames.

The frames of respective layers having the same temporal position in FIG. 1 may be estimated to have similar images, so that the MVs thereof are estimated to be similar. Therefore, a method of efficiently representing an MV by predicting the MV of a current layer based on the MV of a lower layer and encoding the difference between a predicted value and an actually obtained value has been proposed.

FIG. 2 is a view illustrating a method of performing such motion prediction. In accordance with this method, the MV of a lower layer having the same temporal position is used as a predicted MV for the MV of a current layer without change.

An encoder obtains the MVs (MV₀, MV₁, and MV₂) of respective layers with a predetermined accuracy in the respective layers, and performs an inter prediction process of eliminating temporal redundancy from the respective layers using the obtained MVs. However, in practice, the encoder transmits only the MV of a base layer, the MV difference D₁ of the first enhanced layer and the MV difference D₂ of the second enhanced layer to a pre-decoder (to a video stream server). The pre-decoder may transmit only the MV of the base layer to the decoder, the MV of the base layer and the MV difference D₁ of the first enhanced layer to the decoder, or the MV of the base layer, the MV difference D₁ of the first enhanced layer and the MV difference D₂ of the second enhanced layer to the decoder, in conformity with a network condition.

Then the decoder can restore the MVs of corresponding layers based the received data. For example, when the decoder receives the MV of the base layer and the MV difference D₁ of the first enhanced layer, the decoder can restore the MV MV1 of a first enhanced layer by adding the MV of the base layer and the MV difference D₁ of the first enhanced layer and restore the texture data of the first enhanced layer using the restored MV MV1.

In the scalable video coding standard the establishment of which is currently in progress, a method of predicting a layer to which a current block belongs using the correlation between the current block and a lower layer block corresponding to the current block is introduced in addition to inter prediction and directional intra prediction (hereinafter, simply referred to as “intra prediction”) that are used to predict a current block or a macroblock in existing H.264. This prediction method is referred to as “intra BL prediction” in the standard.

FIG. 3 is a schematic view illustrating the three above-described prediction methods. FIG. 3 shows a case (\textcircled{1}) where an intra prediction is made for a specific macroblock 4 of a current frame 1, a case (\textcircled{2}) where an inter prediction is made using a frame 2 located at a temporal location different from that of the current frame 1, and a case (\textcircled{3}) where an intra BL prediction is made using texture data for a region 6 of a base layer frame 3 that corresponds to the macroblock 4. In this case, macroblocks that are encoded by the three prediction methods are referred to as the intra macroblock, the inter macroblock and the intra BL macroblock, respectively.

The scalable video coding standard uses a method of selecting the advantageous one of the three above-described prediction methods and encoding a corresponding macroblock. Therefore, even one frame may be composed of an inter macroblock, an intra macroblock and an intra BL macroblock.

Although a lower layer frame corresponding to a current frame exists, the macroblock of a lower layer corresponding to a specific inter macroblock of the current frame may not be an inter macroblock, so that it is impossible to obtain the MV of the lower layer that is used to predict the MV of the inter macroblock. If the inter macroblock is independently encoded because the MV of a corresponding lower layer does not exit, this may lead to reduced coding efficiency.

Therefore, when the macroblock of a lower layer corresponding to a specific inter macroblock is an intra macroblock or an intra BL macroblock not having an MV, there is the need for a method of efficiently predicting the MV of the inter macroblock.

### SUMMARY OF THE INVENTION

The present invention provides a method and apparatus for generating the missing motion field of a lower layer frame corresponding to a current frame so as to predict the MV of the current frame.

According to an aspect of the present invention, there is provided a method of compressing the MV of the first macroblock of a current layer frame when the region of a first lower layer corresponding to the first macroblock does not have an MV, the method including interpolating the MV of a second macroblock to which the region belongs, based on the MV of at least one neighboring macroblock; acquiring the predicted MV of the first macroblock using the interpolated MV; and subtracting the acquired predicted MV from the MV of the first macroblock.

According to another aspect of the present invention, there is provided an apparatus for compressing the MV of the first macroblock of a current layer frame when the region of a first lower layer corresponding to the first macroblock does not have an MV, the apparatus including a means for interpolating the MV of a second macroblock to which the region belongs, based on the MV of at least one neighboring macroblock; a means for acquiring the predicted MV of the first macroblock using the interpolated MV; and a means for subtracting the acquired predicted MV from the MV of the first macroblock.

According to an aspect of the present invention, there is provided a method of restoring the MV of the first macroblock of a current layer frame from a motion difference for the first macroblock when the region of a first lower layer corresponding to the first macroblock does not have an MV, the method including interpolating the MV of a second macroblock to which the region belongs, based on the MV of at least one neighboring macroblock; acquiring the predicted MV of the first macroblock using the interpolated MV; and adding the motion difference for the first macroblock and the acquired predicted MV.

According to another aspect of the present invention, there is provided an apparatus for restoring the MV of the first macroblock of a current layer frame from a motion difference for the first macroblock when the region of a first lower layer corresponding to the first macroblock does not have an MV, the apparatus including a means for interpolating the MV of a second macroblock to which the region belongs, based on the MV of at least one neighboring macroblock; a means for acquiring the predicted MV of the first macroblock using the interpolated MV; and a means for adding the motion difference for the first macroblock and the acquired predicted MV.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a view showing an example of a scalable video codec using a multi-layered structure;

FIG. 2 is a view illustrating a method of efficiently representing an MV through motion prediction;

FIG. 3 is a schematic view illustrating three types of conventional prediction methods;

FIG. 4 is a schematic view illustrating the basic concept of the present invention;

FIG. 5 is a schematic view illustrating a method of predicting an MV when the resolutions of layers are the same according to a first exemplary embodiment of the present invention;

FIG. 6 is a schematic view illustrating a method of predicting an MV when the resolutions of layers are different according to a first exemplary embodiment;

FIG. 7 is a view illustrating a method of interpolating motion fields according to a second exemplary embodiment of the present invention;

FIG. 8 is a view illustrating a case where four side macroblocks around the macroblock of a first lower layer are taken as neighboring macroblocks according to a second exemplary embodiment of the present invention;

FIG. 9 is a view illustrating a case where eight macroblocks surrounding the macroblock of a first lower layer are taken as neighboring macroblocks according to the second exemplary embodiment of the present invention;

FIG. 10 is a view illustrating a method of allocating MVs to neighboring sub-blocks;

FIG. 11 is a view illustrating a process of performing motion prediction for a current macroblock using an interpolated MV when the resolutions of layers are different;

FIG. 12 is a block diagram showing the construction of a video encoder according to an exemplary embodiment of the present invention;

FIG. 13 is a block diagram showing the construction of a video decoder according to an exemplary embodiment of the present invention;

FIG. 14 is a configuration diagram illustrating the construction of a system environment in which the video encoder of FIG. 12 or the video decoder of FIG. 13 operates; and

FIG. 15 is a flowchart illustrating a motion prediction method according to an exemplary embodiment of the present invention.

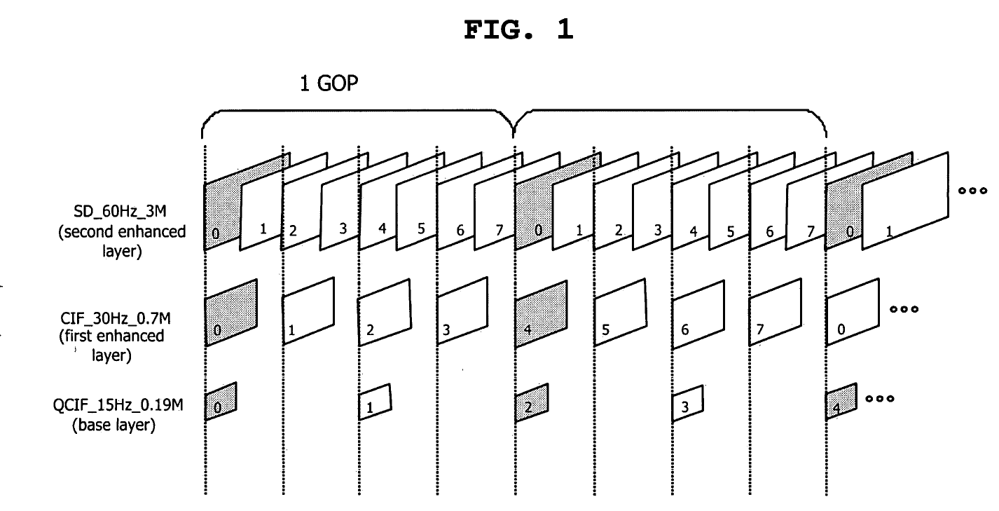

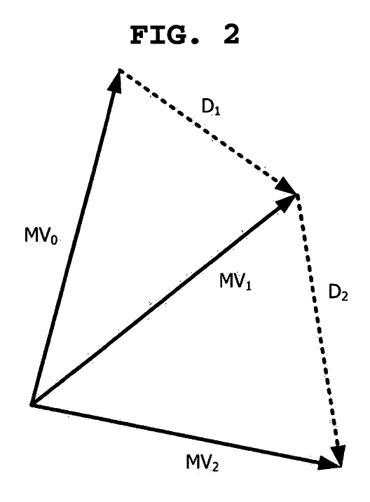

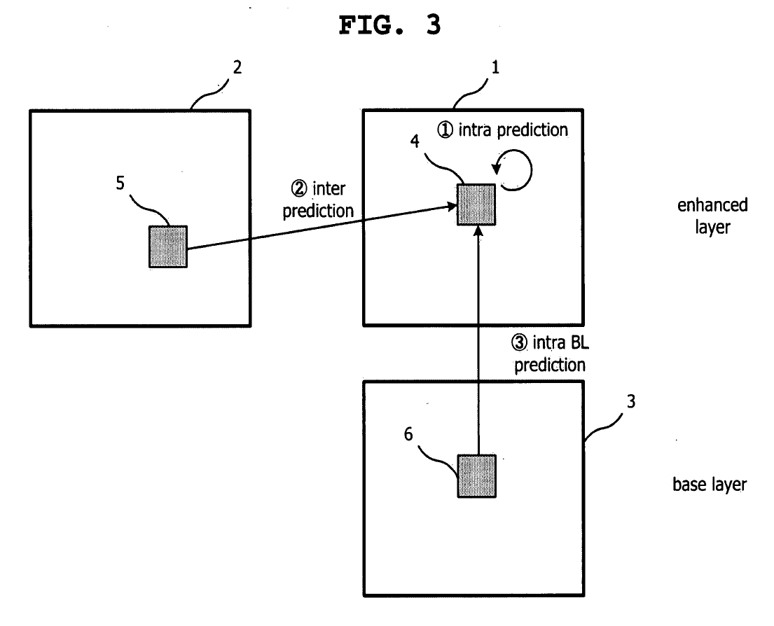

### DESCRIPTION OF THE EXEMPLARY EMBODIMENTS

The present invention is described in detail below in connection with exemplary embodiments with reference to the accompanying drawings.

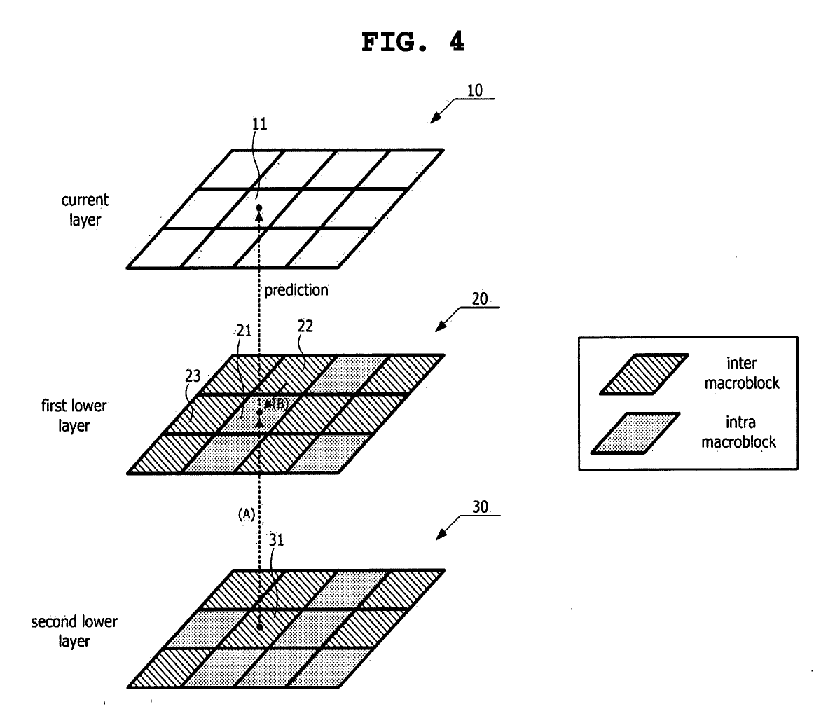

FIG. 4 is a schematic view illustrating the basic concept of the present invention. The MV of the inter macroblock 11 of a current layer frame 10, on which inter prediction will be performed, is efficiently predicted using the MV of a lower layer. However, the block 21 of a first lower layer corresponding to the inter macroblock 11 may or may not correspond to an inter macroblock. In the present specification, the term “block” refers to a macroblock or a region smaller than a macroblock. If the resolutions of the layers are the same, the size of the block 21 of the first lower layer may be the same as the size of the macroblock. In contrast, if the resolutions of the layers are different, the block 21 of the first lower layer may have a size smaller than that of the macroblock.

If the block 21 of the first lower layer is not an inter macroblock, the MV of the block 21 does not exist. Therefore, motion prediction for the inter macroblock 11 cannot be performed using a general method.

In order to use motion prediction even in such a case, two exemplary embodiments are proposed. The first exemplary embodiment is a method of predicting the current layer inter macroblock 11 using the MV of a second lower layer block 31 corresponding to the first lower layer block 21 if the MV of the first lower layer block 21 corresponding to the current inter macroblock 11 does not exist. However, the second lower layer block 31 may also not have an MV. In this case, the following second exemplary embodiment can be employed.

In accordance with the second exemplary embodiment, missing motion fields of a macroblock 21 including the first lower layer block 21 (in FIG. 4, the block 21 has the same size as the macroblock) are interpolated using neighboring inter macroblocks 22, 23, etc. Furthermore, motion prediction for the current inter macroblock 11 can be performed using the interpolated motion fields.

The second exemplary embodiment may be applied only to a case where the first exemplary embodiment cannot be used, but can be independently used regardless of the first exemplary embodiment. That is, the second exemplary embodiment may be used regardless of whether the corresponding block 31 of the second lower layer has an MV, and may also be used even when the second lower layer itself does not exist.

In the present specification, the term “prediction” refers to a process of reducing the amount of data by generating predicted data for specific data using information that can be used in both a video encoder and a video decoder, and obtaining the difference between the specific and the predicted data. Of various types of motion prediction, a process of predicting an original MV using a predicted MV generated by a predetermined method is referred to as “motion prediction.”

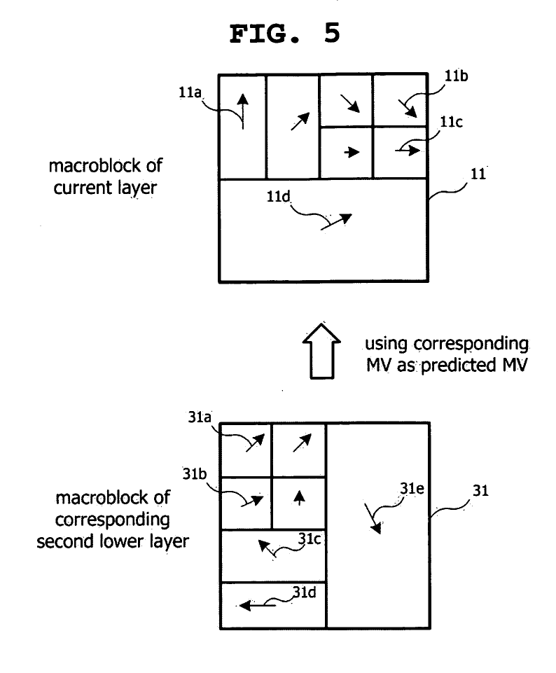

FIG. 5 is a schematic view illustrating a method of predicting an MV according to the first exemplary embodiment when the resolutions of layers are the same. Since a second lower layer and a current layer independently perform motion estimation, they may have different macroblock patterns and MVs.

In FIG. 5, MVs for the macroblock 11 of the current layer are predicted from MVs for the corresponding macroblock 31 of the second lower layer. Since the MVs for the macroblock 11 and the MVs for the macroblock 31 do not have the same macroblock pattern, which to use as a predicted MV is a problem.

In more detail, an MV at a location corresponding to an MV 11a is an MV 31a and an MV 31b. A result that is obtained by averaging, for example, the MV 31a and the MV 31b, can be used as a predicted MV for the MV 11a.

Since an MV at a location corresponding to an MV 11b is an MV 31e, the MV 31e may be used as a predicted MV for the MV 11b. Though the size of a region to which the MV 11b is allocated and the size of a region to which the MV 31e is allocated are different from each other, it can be considered that the region to which the MV 31e is allocated is divided into eight regions and the MV 31e is allocated to each of the eight regions. In the same manner, an MV at a location corresponding to the MV 11c is also the MV 31e.

MVs at a location corresponding to the MV 11d are an MV 31c, an MV 31d and the MV 31e. The corresponding one of a region to which the MV 31e is allocated is only ½ of the region to which the MV 31e is allocated. Therefore, an average resulting from the application of weights to the areas of regions to which MVs are allocated can be used as a predicted MV for the MV 11d, as in the following Equation 1:
mv_{q}=(mv_{31c}+mv_{31d}+2×mv₃₁ₑ)/4 (1)
where mv_{q} is the predicted MV for the MV 11d, mv_{31c} is the MV 31c, mv_{31d} is the MV 31d, and mv₃₁ₑ is the MV 31e.

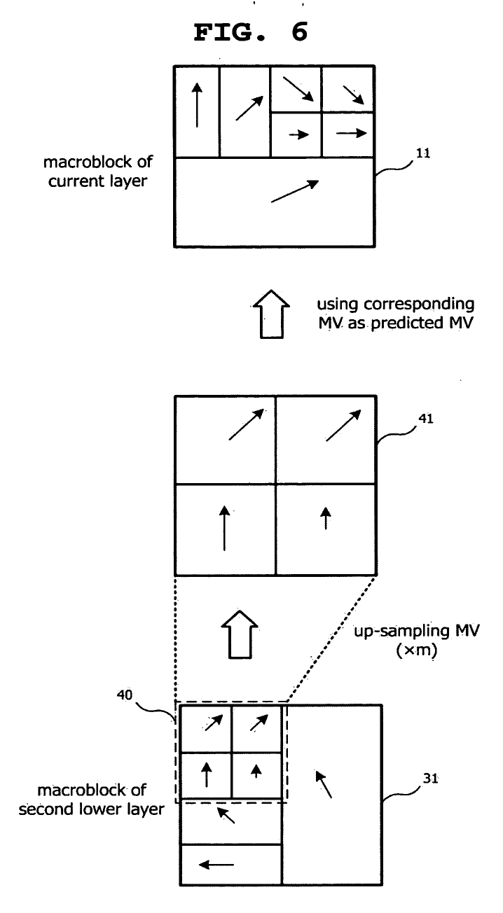

FIG. 6 is a schematic view illustrating a method of predicting an MV according to the first exemplary embodiment when the resolutions of layers are different from each other.

When the resolutions of layers are different, the block 40 of a second lower layer corresponding to the macroblock 11 of a current layer is a part of the macroblock 31 of a predetermined second lower layer. In order to perform motion prediction for the macroblock 11 of the current layer using an MV for the block 40 of the second lower layer, an up-sampling process is necessary. Therefore, MVs allocated to the block 40 of the second lower layer are up-sampled by the resolution magnification (m) of the current layer to that of the second lower layer. MVs for the macroblock 11 of the current layer are then predicted using the up-sampled MVs. In this case, a partition pattern of the macroblock 11 of the current layer and a partition pattern of a region to which the up-sampled MV is allocated can be different from each other. A method of generating a corresponding predicted MV in this case is the same as that described with reference to FIG. 5.

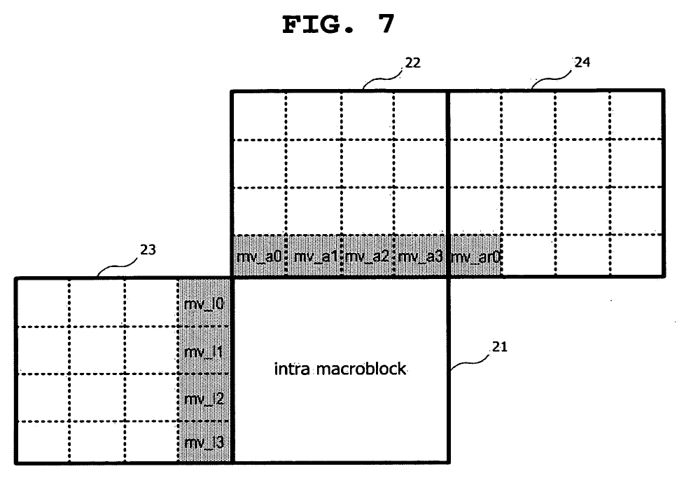

FIG. 7 is a view illustrating a method of interpolating a motion field according to a second exemplary embodiment of the present invention.

When the macroblock 21 of a first lower layer corresponding to the macroblock of a current layer is an intra macroblock (or an intra BL macroblock), it does not have a motion field. In this case, the missing motion field of the macroblock 21 can be interpolated using MVs allocated to neighboring inter macroblocks 22, 23 and 24.

The MV or the motion field of the macroblock 21 is interpolated using the MVs of sub-fields (e.g., 4×4 blocks) neighboring the macroblock 21 within the neighboring inter macroblocks 22, 23 and 24, as in FIG. 7. The following Equation 2 indicates an example of this interpolation method. In this case, mvₚ is an interpolated MV, mvᵢ is the MVs of the neighboring sub-blocks to which reference will be made, and i is the indices of the MVs. In addition, N is the number of neighboring sub-blocks to which reference will be made.

$${mv}_{p} = \frac{{\sum }_{i = 0}^{N - 1} {mv}_{i}}{N} \qquad ( 2 )$$

If the number of neighboring sub-blocks to which reference is made is 9, as in FIG. 5, the interpolated MV mvₚ can be acquired, as in the following Equation 3.
mvₚ=(mv_{—}10+mv_{—}11+mv_{—}12+mv_{—}13+mv_a0+mv_a1+mv_a2+mv_a3+mv_ar0)/9 (3)

The reason why the number of neighboring sub-blocks is 9, as in FIG. 7, is to maintain consistency with a conventional method of predicting/compressing the MV of a single layer using neighboring MVs. However, the present invention is not limited to this method, but can be applied to another method of selecting neighboring sub-blocks to which reference will be made and applying Equation 2.

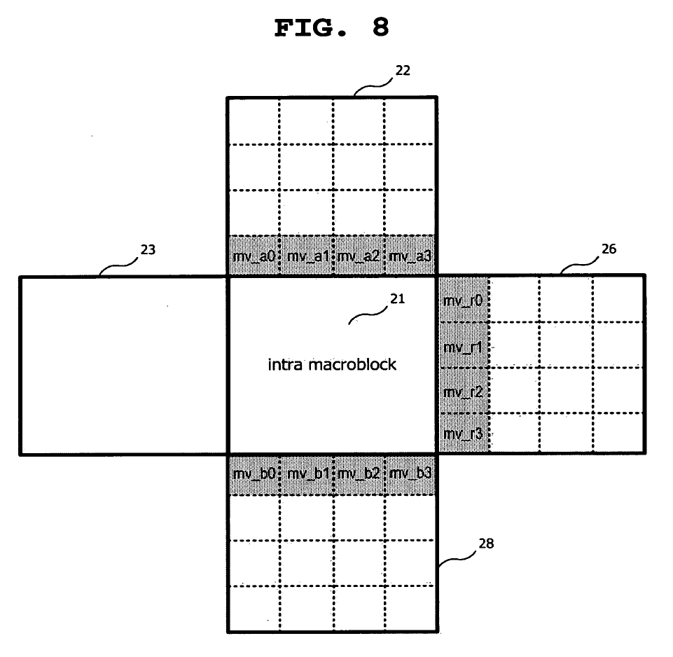

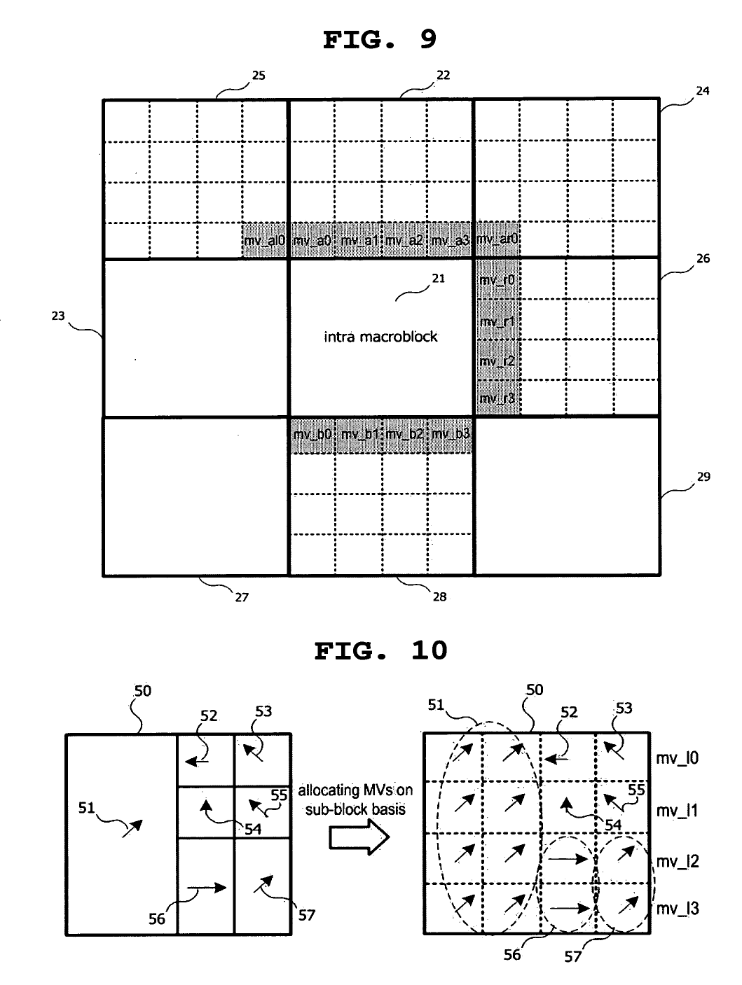

More particularly, in the case of inter-layer motion prediction, unlike prediction in a single layer, reference can be made to right and lower macroblocks as well as left and upper macroblocks. Therefore, a method of selecting only inter macroblocks from macroblocks neighboring the macroblock 21 and utilizing the MVs of the neighboring sub-blocks of the selected inter macroblocks can be considered. Examples of the method are shown in FIGS. 8 and 9.

FIG. 8 shows a case where four side macroblocks 22, 23, 26 and 28 are taken as neighboring macroblocks and FIG. 9 shows a case where eight macroblocks 22 to 29 surrounding the macroblock 21 of a first lower layer are taken as neighboring macroblocks.

In FIG. 8, the left macroblock 23 of the four neighboring macroblocks is an intra macroblock (or an intra BL macroblock) and the remaining three-macroblocks 22, 26 and 28 are inter macroblocks. In this case, since the number of neighboring sub-blocks to which reference is made in Equation 2 is 12, the MV of the intra macroblock 21 can be interpolated by averaging MVs that are respectively allocated to the twelve sub-blocks.

Meanwhile, in FIG. 9, the left, lower left and lower right macroblocks 23, 27, 29 of nine neighboring macroblocks are intra macroblocks (or intra BL macroblocks) and the remaining five-macroblocks 22, 24, 25, 26 and 28 are inter macroblocks. In this case, since the number of neighboring sub-blocks to which reference is made in Equation 2 is 14, the MV of the intra macroblock 21 can be interpolated by averaging MVs that are respectively allocated to the five sub-blocks.

The MV mvₚ that is calculated as described above represents the entire macroblock 21 of the first lower layer.

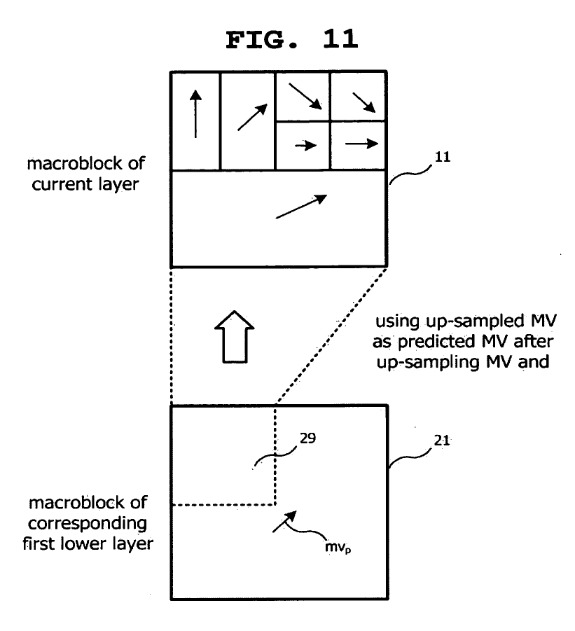

Further, there are cases where the sizes of blocks to which MVs are allocated are not uniform. In these general cases, how to acquire the MVs of neighboring sub-blocks is described below. In FIG. 10, a specific inter macroblock 50 has a predetermined partition pattern, and an MV is allocated to each partition. Meanwhile, partitions include partitions 52, 53, 54 and 55 having a 4×4 sub-block size, and partitions 51, 56 and 57 having a size larger than the 4×4 sub-block size. If MVs are allocated on a 4×4 sub-block basis, it will result in the right-hand drawing of FIG. 10. At this time, partitions the size of which is larger than the 4×4 sub-block size are each divided into some sub-blocks, and the motion vectors of the partitions are allocated to the sub-blocks in the same manner.

If the macroblock 50 is the macroblock 23 of FIG. 5, mv_10 is the same as the MV 53, mv_11 is the same as the MV 55, and mv_12 and mv_13 are the same as the MV 57. It is thus possible to determine the MVs of all neighboring sub-blocks through the allocation of MVs on a sub-block basis.

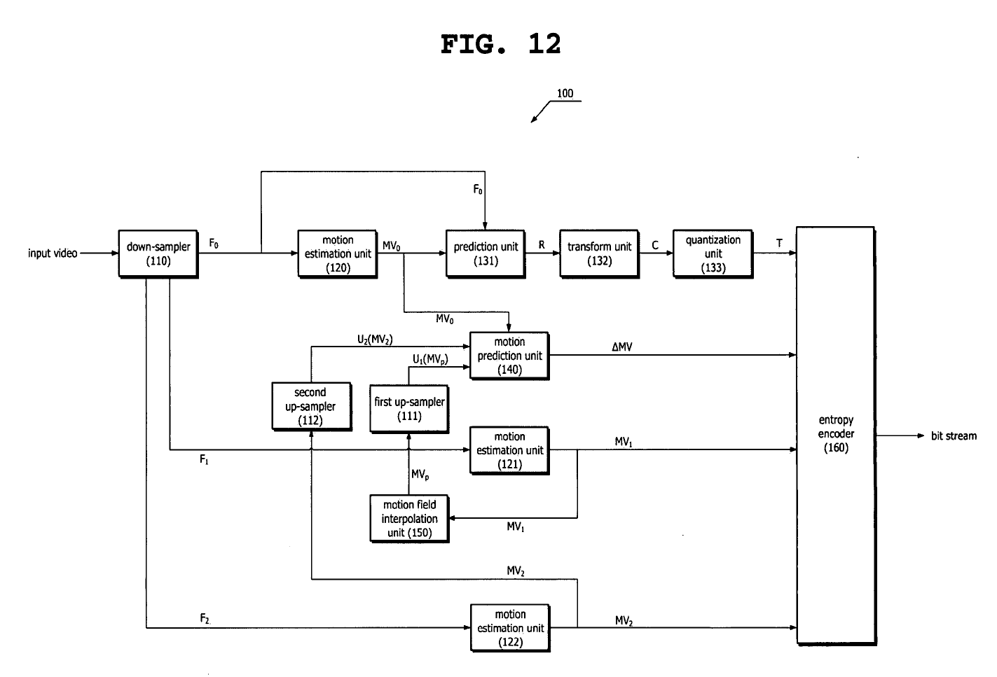

FIG. 11 is a view illustrating a process of performing motion prediction for a current macroblock using an interpolated MV (mvₚ) when the resolutions of layers are different. The interpolated MV (mvₚ) is up-sampled by the ratio of the resolution of a current layer to the resolution of the first enhanced layer, and is then used as the predicted MV of a current macroblock 11. Since the region 29 of the first lower layer macroblock 21 corresponding to the current macroblock 11 is a part of the first lower layer macroblock 21, the MV of the region 29 is the same as the MV (mvₚ) of the first lower layer macroblock 21.

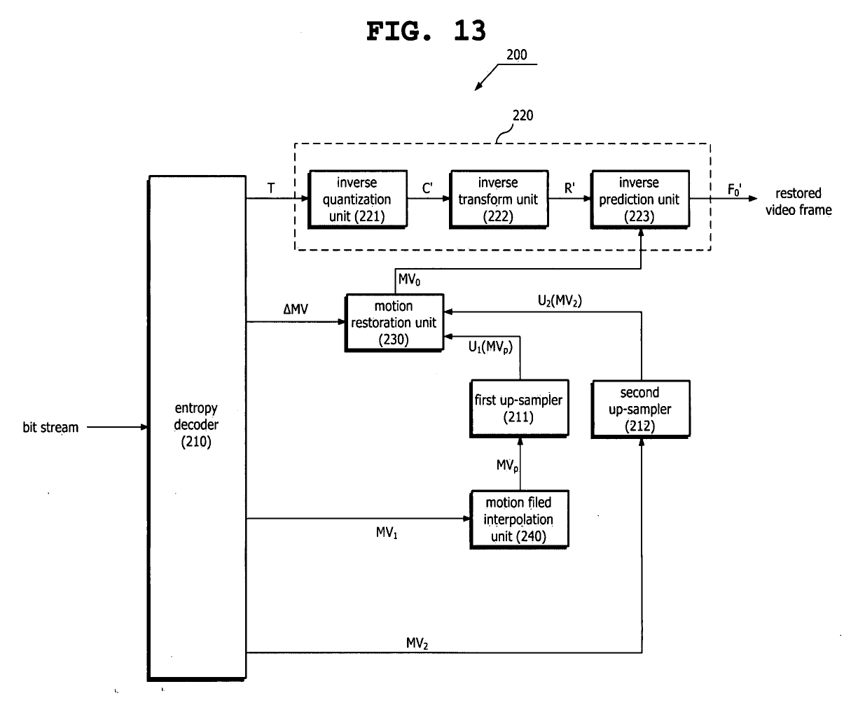

FIG. 12 is a block diagram showing the construction of a video encoder 100 according to an exemplary embodiment of the present invention.

A down-sampler 110 down-samples input video to a resolution and frame rate appropriate for each layer. The down-sampler 110 may perform down-sampling with respect only to the resolutions of layers, or with respect only to the frame rate. Alternatively, the down-sampler 110 may also perform down-sampling with respect to both the resolution and the frame rate. The down sampling associated with the resolution may be performed using a MPEG down-sampler or a wavelet down-sampler. The down sampling associated with the frame rate may be performed using a method such as frame skip or frame interpolation. As a result of such down-sampling, a current layer frame F₀, a first lower layer frame F₁ and a second lower layer frame (F₂) can be produced. It is assumed that the frames F₀, F₁ and F₂ exist at respective temporally corresponding locations.

A motion estimation unit 120 acquires the MV MV₀ of a current layer frame by performing motion estimation on the current layer frame (F₀) using another frame of the current layer as a reference frame. Such motion estimation is a process of finding a block that is the most similar to the block of the current frame in the reference frame, that is, that has the lowest error. A variety of methods, such as a fixed-size block matching method or a Hierarchical Variable Size Block Matching (HVSBM), can be used for the motion estimation.

In the same manner, a motion estimation unit 121 acquires the MV MV₁ of the frame F₁ of the first lower layer, and a motion estimation unit 122 acquires the MV MV₂ of the frame F₂ of the second lower layer. The MV (MV1) acquired by the motion estimation unit 121 is provided to a motion field interpolation unit 150 and an entropy encoder 160. The MV (MV2) acquired by the motion estimation unit 122 is provided to a second up-sampler 112 and the entropy encoder 160.

The motion field interpolation unit 150 interpolates the MV of the macroblock of the frame F₁ of a first lower layer corresponding to a specific macroblock (hereinafter referred to as a “current macroblock”) of the current layer frame F₀ using the MVs of neighboring macroblocks. Since the interpolation method has been described with reference to FIGS. 7 to 11, a description thereof is omitted to avoid redundancy. As described above, the interpolated MV MVₚ is provided to a first up-sampler 111. The first up-sampler 111 up-samples the interpolated MV by the ratio of the resolution of the current layer to the resolution of the first lower layer. If the resolutions of the first lower layer and the current layer are the same, the up-sampling in the first up-sampler 111 can be omitted. The up-sampled MV U₁(MVₚ) is provided to the motion prediction unit 140.

The second up-sampler 112 up-samples the MV MV₂, which is received from the motion estimation unit 122, by the ratio of the resolution of the current layer to the resolution of the second lower layer, and provides a result U₂(MV₂) to the motion prediction unit 140.

The motion prediction unit 140 employs the motion prediction method (the first exemplary embodiment or the second exemplary embodiment) according to the present invention when the region of the first lower layer corresponding to the current macroblock does not have an MV. In this case, the motion prediction unit 140 determines whether the region of the second lower layer corresponding to the region of the first lower layer has an MV. If, as a result of the determination, the region of the second lower layer is determined to have an MV, the motion prediction unit 140 employs the first exemplary embodiment. Otherwise the motion prediction unit 140 employs the second exemplary embodiment. Of course, the motion prediction unit 140 can directly employ the second exemplary embodiment without performing such determination.

When the first exemplary embodiment is employed, the motion prediction unit 140 subtracts the MV of a region corresponding to the current macroblock, among the MV U₂(MV₂) up-sampled by the second up-sampler 112, from the MV of the current macroblock, among the MV (MV₀) of the current frame.

When the second exemplary embodiment is employed, the motion prediction unit 140 subtracts the MV of the region corresponding to the current macroblock, among the MV U₁(MV₂) up-sampled by the first up-sampler 111, from the MV of the current macroblock.

As described above, a motion difference ΔMV which is generated as a result of the subtraction in the motion prediction unit 140 is provided to the entropy encoder 160.

Meanwhile, a prediction unit 131 constructs the predicted frame of the current frame F₀ using the MV MV₀ of the current frame obtained in the motion estimation unit 120 and the reference frame used in the motion estimation unit 120, and subtracts the constructed predicted frame from the current frame. As a result, a residual frame R is produced.

A transform unit 132 performs spatial transform on the residual frame R and generates a transform coefficient C. This spatial transform method includes Discrete Cosine Transform (DCT), wavelet transform, etc. When DCT is used, the transform coefficient is a DCT coefficient. When wavelet transform is used, the transform coefficient is a wavelet coefficient.

A quantization unit 133 quantizes the transform coefficient C. The term “quantization” refers to a process of representing a transform coefficient, which has been represented as a predetermined real number, as discrete values by dividing the real number transform coefficient into predetermined sections, and matching the values to indices based on a predetermined quantization table.

The entropy encoder 160 losslessly encodes a result T, which is quantized by the quantization unit 133, the motion difference ΔMV, the MV MV₁ of the first lower layer and the MV MV₂ of the second lower layer, and produces a bit stream. Of course, when the video encoder 100 employs only the second exemplary embodiment, MV₂ can be omitted. A variety of coding methods, such as Huffman coding, arithmetic coding and variable length coding, are usable as the lossless coding method.

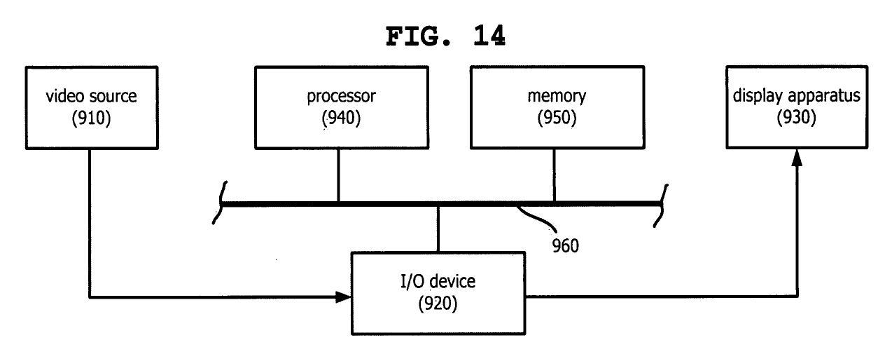

FIG. 13 is a block diagram showing the construction of a video decoder 200 according to an exemplary embodiment of the present invention.

An entropy decoder 210 performs lossless decoding, and extracts the texture data T of a current layer frame, a motion difference ΔMV for a current layer, the MV MV₁ of a first lower layer and the MV MV₂ of a second lower layer from an input bit stream.

A motion field interpolation unit 240 interpolates the MV of the macroblock of the first lower layer corresponding to the current macroblock of the current layer frame F₀ based on the MV (included in MV₁) of a neighboring macroblock. Since this interpolation method has been described with reference to FIGS. 7 to 11, a description thereof is omitted to avoid redundancy. As described above, the interpolated MV MVₚ is provided to a first up-sampler 211. The first up-sampler 211 up-samples the interpolated MV by the ratio of the resolution of the current layer to the resolution of the first lower layer. Of course, if the resolutions of the first lower layer and the current layer are the same, the up-sampling by the first up-sampler 211 can be omitted. The up-sampled MV U₁(MVₚ) is provided to a motion restoration unit 230.

Meanwhile, a second up-sampler 212 up-samples the MV MV₂ of the second lower layer by the ratio of the resolution of the current layer to the resolution of the second lower layer. The result U₂(MV₂) is provided to the motion restoration unit 230.

A motion restoration unit 230 uses the motion prediction method (the first exemplary embodiment or the second exemplary embodiment) according to the present invention when the region of the first lower layer corresponding to the current macroblock does not have an MV. In this case, the motion restoration unit 230 determines whether the region of the second lower layer corresponding to the region of the first lower layer has an MV. If, as a result of the determination, the region of the second lower layer is determined to have an MV, the motion restoration unit 230 employs the first exemplary embodiment. If the region of the second lower layer does not have an MV, the motion restoration unit 230 employs the second exemplary embodiment. Of course, the motion restoration unit 230 can directly employ the second exemplary embodiment without the determination.

When the first exemplary embodiment is employed, the motion restoration unit 230 adds a motion difference ΔMV for the current macroblock, among the MV MV₀ of the current frame, and the MV of the region corresponding to the current macroblock, among the MV U₂(MV₂) up-sampled by the second up-sampler 212.

When the second exemplary embodiment is employed, the motion restoration unit 230 adds the motion difference ΔMV, and the MV of a region corresponding to the current macroblock, among the MV U₁(MV₂) up-sampled by the first up-sampler 211. Through this addition process, the MV MV₀ for the current macroblock is restored and is provided to an inverse prediction unit 223.

Meanwhile, an inverse quantization unit 221 inversely quantizes texture data T output from the entropy decoder 210. Inverse quantization is a process of restoring a value matching indices, which are generated in a quantization process, using a quantization table, which is used in the quantization process, without change.

An inverse transform unit 222 performs an inverse spatial transform process on the inverse quantized result. This inverse spatial transform process is performed in a way corresponding to the transform unit 132 of the video encoder 100. More particularly, inverse DCT transform, inverse wavelet transform or the like may be used.

The inverse prediction unit 223 inversely performs the process, which is performed in the temporal transform unit 131, on the inversely transformed result and, thus, restores a video frame. That is, the inverse prediction unit 223 restores the video frame by producing a predicted frame using an MV restored in the motion restoration unit 230, and adding the inversely transformed result and the generated predicted frame.

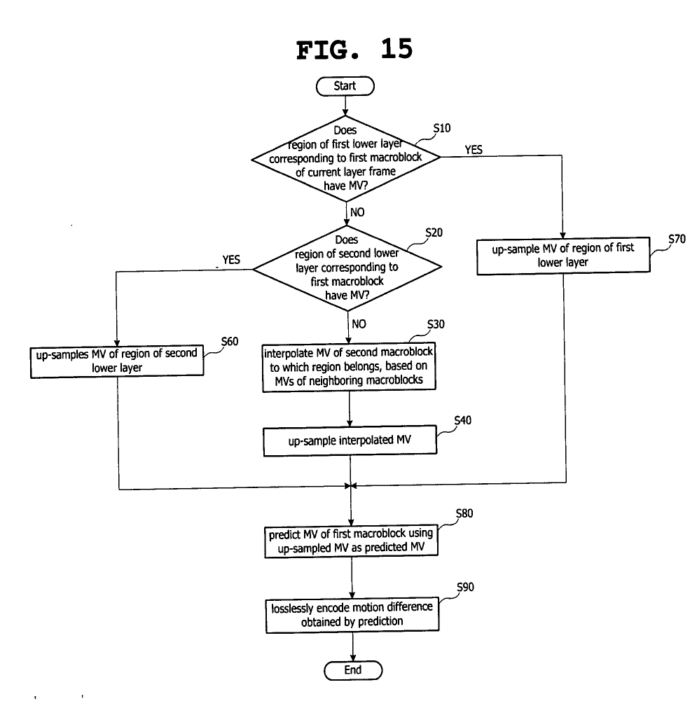

FIG. 14 is a configuration diagram illustrating the construction of a system environment in which the video encoder 100 of FIG. 12 or the video decoder 200 of FIG. 13 operates, according to an exemplary embodiment of the present invention. The system may be a television (TV), a set-top box, a desktop computer, a laptop computer, a palmtop computer, a Personal Digital Assistant (PDA), or a video or image storage device (e.g., a Video Cassette Recorder (VCR), a Digital Video Recorder (DVR), etc.). In addition, the system may be a combination of the above-described devices, or one of the above-described devices that is included in another. The system may include at least one video source 910, at least one Input/Output (I/O) device 920, a processor 940, a memory 950 and a display apparatus 930.

The video source 910 may be a TV receiver, a VCR or some other video storage device. Furthermore, the video source 910 may be at least one network connection for receiving video from a server via the Internet, a Wide Area Network (WAN), a Local Area Network (LAN), a terrestrial broadcasting system, a cable network, a satellite communication network, a wireless network, a telephone network or the like. In addition, the video source can be a combination of the above-described networks, or one of the above-described networks that is included in another.

The I/O device 920, the processor 940 and the memory 950 communicate with each other via a communication medium 960. The communication medium 960 may be a communication bus, a communication network, or at least one internal connection circuit. Input video data received from the video source 910 may be processed by the processor 940 in accordance with at least one software program stored in the memory 950, and may be executed by the processor 940 so as to generate output video that is provided to the display apparatus 930.

In particular, the software program stored in the memory 950 may include a multi-layered video codec that performs the method according to the present invention. The codec may be stored in the memory 950, may be read from a storage medium such as a CD-ROM or a floppy disk, or may be downloaded from a predetermined server via one of various networks. The codec may be replaced with software, a hardware circuit, or a combination of software and a hardware circuit.

FIG. 15 is a flowchart illustrating a motion prediction method according to an exemplary embodiment of the present invention.

First, the motion prediction unit 140 determines whether the region of a first lower layer corresponding to the first macroblock of a current layer frame has an MV at operation S10. If, as a result of the determination, the region of the first lower layer is determined to have the MV (YES at S10), the first up-sampler 112 up-samples the MV of the region of the first lower layer and provides the up-sampled MV to the motion prediction unit 140 at operation S70. The motion prediction unit 140 predicts the MV of the first macroblock using the up-sampled MV as a predicted MV at operation S80. Since operation S70 is the same as that of the prior art, a detailed description thereof has been omitted in the description of FIG. 15.

If, as a result of the determination at operation S10, the region of the first lower layer is determined not to have an MV (NO at operation S10), the motion prediction unit 140 determines whether the region of a second lower layer corresponding to the first macroblock has an MV at operation S20. If, as a result of the determination, the region of the second lower layer is determined to have an MV (YES at operation S20), the second up-sampler 111 up-samples the MV of the region of the second lower layer by the ratio of the resolution of the current layer to the resolution of the second lower layer at operation S60. In this case, the up-sampling may be omitted when the resolutions of layers are the same. The motion prediction unit 140 predicts the MV of the first macroblock using the up-sampled MV as a predicted MV at operation S80.

Meanwhile, if, as a result of the determination at operation S20, the region of the second lower layer is determined not to have an MV (NO at operation S20), the motion field interpolation unit 150 interpolates the MV of the second macroblock, which corresponds to the current macroblock, based on neighboring macroblocks at operation S30. In this case, the second macroblock is an intra macroblock or an intra BL macroblock.

The interpolation method may be performed by averaging the MVs of neighboring sub-blocks within the inter macroblock of the neighboring macroblocks (refer to Equation 2). More particularly, the sub-blocks may include four 4×4 sub-blocks (mv_{—}10, mv_{—}11, mv_{—}12 and mv_{—}13 in FIG. 7) that are within a macroblock on the left side of the first macroblock and neighbor the first macroblock, four 4×4 sub-blocks (mv_a0, mv_a1, mv_a2 and mv_a3 in FIG. 7) that are within a macroblock on an upper side of the first macroblock and neighbor the first macroblock, and one 4×4 sub-block (mv_ar0 in FIG. 7), that is within a macroblock on an upper right side of the first macroblock and is closest to the first macroblock.

The up-sampler 111 up-samples the interpolated MV by the ratio of the resolution of the current layer to the resolution of the first lower layer at operation S40. The up-sampling may be omitted if the resolutions of layers are the same. The motion prediction unit 140 predicts the MV of the first macroblock using the up-sampled MV as a predicted MV at operation S80. Operation S80 includes acquiring a predicted MV using the interpolated MV and subtracting the acquired predicted MV from the MV of the first macroblock.

Finally, in operation S90, the entropy encoder 160 losslessly encodes the motion difference MV, which is acquired through the prediction at operation S80.

Operations S30 and S40 may be performed if the result of the determination at operation S20 is NO, or may be performed regardless of the determination at operation S20, as described above.

Although the description of FIG. 15 has been given so far on the basis of the video encoder 100, operations S10 to S70 are performed in the same manner in the video decoder 200. However, in this case, operation S80 is replaced with the operation of adding the motion difference ΔMV, which is provided by the entropy decoder 210, to the up-sampled MV, which is used as the predicted MV, and there is no operation corresponding to the operation S90.

As described above, the present invention can improve video compression performance by efficiently predicting multi-layered MVs.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of compressing a motion vector (MV) of a first macroblock of a current layer frame if a region of a first lower layer corresponding to the first macroblock does not have an MV, the method comprising:
interpolating an MV of a second macroblock to which the region belongs, based on an MV of at least one neighboring macroblock;
acquiring a predicted MV of the first macroblock using the interpolated MV; and
subtracting the predicted MV of the first macroblock from the MV of the first macroblock.

2. The method as set forth in claim 1, further comprising losslessly encoding a result of the subtracting.

3. The method as set forth in claim 1, wherein the second macroblock is an intra macroblock or an intra BL macroblock.

4. The method as set forth in claim 1, wherein the acquiring the predicted MV of the first macroblock comprises up-sampling the interpolated MV by a ratio of a resolution of the current layer to a resolution of the first lower layer.

5. The method as set forth in claim 1, further comprising determining whether a region of a second lower layer corresponding to the region of the first lower layer has an MV;
wherein the interpolating, the acquiring and the subtracting are performed only if the region of the second lower layer is determined not to have the MV.

6. The method as set forth in claim 5, further comprising predicting the MV of the first macroblock using an MV of the region of the second lower layer if the region of the second lower layer is determined to have the MV.

7. The method as set forth in claim 6, wherein the predicting the MV of the first macroblock comprises:
up-sampling the MV of the region of the second lower layer by a ratio of a resolution of the current layer to a resolution of the second lower layer; and
subtracting the up-sampled MV from the MV of the first macroblock.

8. The method as set forth in claim 1, wherein the interpolating the MV of the second macroblock comprises averaging MVs of neighboring sub-blocks within an inter macroblock of the neighboring macroblocks.

9. The method as set forth in claim 8, wherein the neighboring sub-blocks comprise four sub-blocks that are within a macroblock on a left side of the first macroblock and neighbor the first macroblock, four sub-blocks that are within a macroblock on an upper side of the first macroblock and neighbor the first macroblock, and one sub-block that is within a macroblock on an upper right side of the first macroblock and is closest to the first macroblock.

10. An apparatus for compressing a motion vector (MV) of a first macroblock of a current layer frame when a region of a first lower layer corresponding to the first macroblock does not have an MV, the apparatus comprising:
a motion field interpolation unit which interpolates an MV of a second macroblock to which the region belongs, based on an MV of at least one neighboring macroblock;
means for acquiring a predicted MV of the first macroblock using the interpolated MV; and
means for subtracting the predicted MV of the first macroblock from the MV of the first macroblock.

11. The apparatus as set forth in claim 10, further comprising means for losslessly encodes a result of the subtraction.

12. The apparatus as set forth in claim 10, wherein the second macroblock is an intra macroblock or an intra BL macroblock.

13. The apparatus as set forth in claim 10, wherein the means for acquiring the predicted MV up-samples the interpolated MV by a ratio of a resolution of the current layer to a resolution of the first lower layer.

14. The apparatus as set forth in claim 10, further comprising means for determining whether a region of a second lower layer corresponding to the region of the first lower layer has an MV;
wherein, only if the region of the second lower layer is determined not to have the MV, the interpolation means, the predicted MV acquisition means and the subtraction means operate.

15. The apparatus as set forth in claim 14, further comprising means for predicting the MV of the first macroblock using an MV of the region of the second lower layer if the region of the second lower layer is determined to have the MV.

16. The apparatus as set forth in claim 15, wherein the means for predicting the MV of the first macroblock comprises:
means for up-sampling the MV of the region of the second lower layer by a ratio of a resolution of the current layer to a resolution of the second lower layer; and
means for subtracting the up-sampled MV from the MV of the first macroblock.

17. The apparatus as set forth in claim 10, wherein the interpolation means averages MVs of neighboring sub-blocks within an inter macroblock of the neighboring macroblocks.

18. The apparatus as set forth in claim 17, wherein the neighboring sub-blocks comprise four sub-blocks that are within a macroblock on a left side of the first macroblock and neighbor the first macroblock, four sub-blocks that are within a macroblock on an upper side of the first macroblock and neighbor the first macroblock, and one sub-block that is within a macroblock on an upper right side of the first macroblock and is closest to the first macroblock.

19. A method of restoring a motion vector (MV) of a first macroblock of a current layer frame from a motion difference for the first macroblock when a region of a first lower layer corresponding to the first macroblock does not have an MV, the method comprising:
interpolating an MV of a second macroblock to which the region belongs, based on an MV of at least one neighboring macroblock;
acquiring a predicted MV of the first macroblock using the interpolated MV; and
adding the motion difference for the first macroblock and the predicted MV of the first macroblock.

20. The method as set forth in claim 19, wherein the second macroblock is an intra macroblock or an intra BL macroblock.

21. The method as set forth in claim 19, wherein the acquiring the predicted MV of the first macroblock comprises up-sampling the interpolated MV by a ratio of a resolution of the current layer to a resolution of the first lower layer.

22. The method as set forth in claim 19, wherein the interpolating the MV of the second macroblock comprises averaging MVs of neighboring sub-blocks within an inter macroblock of the neighboring macroblocks.

23. The method as set forth in claim 19, wherein the neighboring sub-blocks comprise four sub-blocks that are within a macroblock on a left side of the first macroblock and neighbor the first macroblock, four sub-blocks that are within a macroblock on an upper side of the first macroblock and neighbor the first macroblock, and one sub-block that is within a macroblock on an upper right side of the first macroblock and is closest to the first macroblock.

24. An apparatus for restoring a motion vector (MV) of a first macroblock of a current layer frame from a motion difference for the first macroblock when a region of a first lower layer corresponding to the first macroblock does not have an MV, the apparatus comprising:
means for interpolating an MV of a second macroblock to which the region belongs, based on an MV of at least one neighboring macroblock;
means for acquiring a predicted MV of the first macroblock using the interpolated MV; and
means for adding the motion difference for the first macroblock and the predicted MV of the first macroblock.

25. The apparatus as set forth in claim 24, wherein the second macroblock is an intra macroblock or an intra BL macroblock.

26. The apparatus as set forth in claim 24, wherein the means for acquiring the predicted MV of the first macroblock up-samples the interpolated MV by a ratio of a resolution of the current layer to a resolution of the first lower layer.

27. The apparatus as set forth in claim 24, wherein the means for interpolating the MV of the second macroblock averages MVs of neighboring sub-blocks within an inter macroblock of the neighboring macroblocks.

28. The apparatus as set forth in claim 24, wherein the neighboring sub-blocks comprise four sub-blocks that are within a macroblock on a left side of the first macroblock and neighbor the first macroblock, four sub-blocks that are within a macroblock on an upper side of the first macroblock and neighbor the first macroblock, and one sub-block that is within a macroblock on an upper right side of the first macroblock and is closest to the first macroblock.
